(19) United States
(12) Patent Application Publication
(10) Pub. No.: US 2004/0205523 A1
(43) Pub. Date: Oct. 14, 2004

(54) Control chart with single display

(75) Inventors: Alfred E. Miller, Keokuk, IA (US); William D. Patterson, Quincy, IL (US); Terry J. Hostert, Macomb, IL (US)

Correspondence Address: BLANK ROME LLP, 600 NEW HAMPSHIRE AVENUE, N.W., WASHINGTON, DC, 20037, US

(73) Assignee: METHODE ELECTRONICS, INC.

(21) Appl. No.: 10/157,848

(22) Filed: May 31, 2002

Related U.S. Application Data
(60) Provisional application No. 60/334,599, filed on Dec. 3, 2001.

(51) Int. Cl. G06F 17/24

(52) U.S. Cl. 715/503

(57) ABSTRACT

A statistical process control chart includes a single display for the data and for an analysis of the data, e.g., in the form of one or more graphical charts. The chart can be implemented in a spreadsheet having multiple pages, including a page for entry of the data and a page implementing the single display. Space is also provided for entry of root causes and corrective action. The analysis performed on the data can include a Pareto analysis or a graph of an error rate in parts per million.

### REFERENCE TO RELATED APPLICATION

The present application claims the benefit of U.S. Provisional Application No. 60/334,599 (Confirmation No. 7739), filed Dec. 3, 2001, whose disclosure is hereby incorporated by reference in its entirety into the present application.

### FIELD OF THE INVENTION

The present invention is directed to an attribute control chart (otherwise known as a statistical process control chart, or an SPC chart), which is preferably implemented as a spreadsheet in MS Excel or a spreadsheet having equivalent functionality, and more particularly to such a control chart having a single interface.

### DESCRIPTION OF RELATED ART

Statistical process control (SPC) optimizes an industrial process by monitoring one or more characteristics of the product or process over time. Typically, the user inputs data representing the one or more characteristics at time intervals into an SPC chart. A statistical analysis is performed on the data to determine whether the process is running optimally and, if not, to determine the causes, and implement corrective actions.

For example, in a manufacturing process, data involving manufacturing errors can be input at given times, e.g., at shift changes. If the data identify the number of manufacturing errors for each given cause, a Pareto analysis can be performed to identify the leading causes. The underlying principle in a Pareto analysis is that a problem can be solved most efficiently by concentrating on the most frequently occurring causes of the problem. Therefore, the purpose of a Pareto analysis is to identify those most frequently occurring causes.

In a Pareto analysis, the causes are ranked by frequency of occurrence, from most common to rarest. Each cause is represented by two variables. The first variable is the frequency of occurrence of that cause. The second is the cumulative frequency of occurrence, which is the sum of the frequencies of occurrence of that cause and of all more common causes. For example, if the first, second, and third most common causes of manufacturing errors occur 16%, 14%, and 13% of the time, respectively, their cumulative frequencies of occurrence are 16%, 16%+14%=30%, and 16%+14%+13%=43%, respectively. Once the cumulative frequency of occurrence reaches some threshold, such as 80%, the most frequently occurring causes have been identified and should be corrected first.

A graphical representation of a Pareto analysis is shown in FIG. 1. The bar chart represents the frequency of occurrence of each cause, while the line represents the cumulative frequency. The horizontal line at 80% gives a readily intelligible representation of the point at which the cumulative frequency reaches the threshold.

Of course, the utility of SPC charts is not limited to Pareto analysis. Any other suitable analysis can be used.

It will be readily appreciated that an SPC chart can be implemented in a computer-based system. An advantage of doing so is that the result can be updated automatically as new data are entered. Existing products are exemplified by the SPCI+ Navigator, published by Advanced Systems & Design, and U.S. Pat. No. 5,392,226 to Hamilton. However, both of those products have disadvantages. For example, neither of them places all features on one display; instead, they both require the user to switch back and forth among multiple displays. Also, both of them require the installation of special software.

### SUMMARY OF THE INVENTION

In light of the above, it will be apparent that a need exists in the art for a computer-implemented SPC chart that does not require the user to switch back and forth among displays. It is therefore an object of the invention to implement such a chart having a single display. It is a further object of the invention to implement such a chart in such a way that it preferably uses existing software (e.g., a spreadsheet program) that most users are likely to have.

To achieve the above and other objects, the present invention differs from the prior art, e.g., in that all of the features are placed and utilized on one display. As such, the display is all-inclusive with respect to the data and analysis of the data in one format. In a particular embodiment, the chart indexes for the latest 25 subgroups.

The invention can be implemented for use with a standard spreadsheet program. A preferred embodiment uses a file in .XLS format for use with Microsoft Excel. Of course, the present invention could be used with any other spreadsheet or other software having sufficient capabilities in terms of computing and graphics. The spreadsheet software should preferably be capable of using multi-page spreadsheet files.

All aspects of closed loop process control can be demonstrated on the chart.

Areas (e.g., spreadsheet cells) can be provided for text entry of a root cause of each error and of the corrective action taken.

### BRIEF DESCRIPTION OF THE DRAWINGS

A preferred embodiment of the present invention will be set forth in detail with reference to the drawings, in which:

FIG. 1 shows a graphical representation of a conventional technique in Pareto analysis;

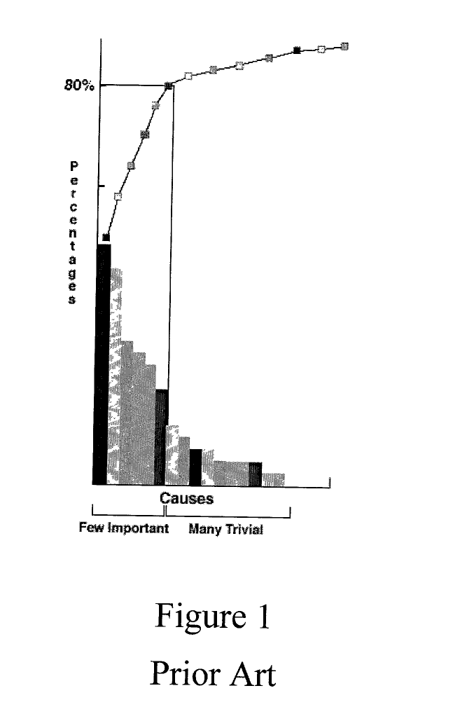

FIG. 2 shows an overview of hardware on which the present invention can be implemented;

FIG. 3 shows an organization of a spreadsheet file used in the preferred embodiment;

FIG. 4 shows an overview of a display of results provided by the spreadsheet file of FIG. 3; and

FIG. 5 shows a flow chart of steps in using the spreadsheet file of FIG. 3.

### DETAILED DESCRIPTION OF THE PREFERRED EMBODIMENT

A preferred embodiment of the present invention will now be set forth in detail with reference to the drawings, in which like reference numerals refer to like elements or method steps throughout.

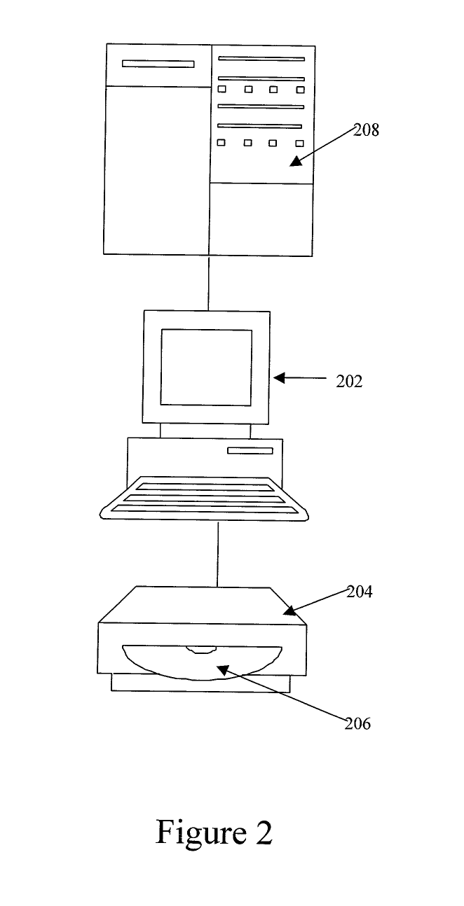

An example of a hardware setup on which the preferred embodiment can be used is shown in FIG. 2. A user uses the preferred embodiment on a workstation 202, which can be any suitable device, such as a Windows-compatible microcomputer having a spreadsheet program installed thereon. The file or files used in the preferred embodiment can be provided in any suitable way and loaded into the RAM of the workstation 202. Two examples are the use of a local disk drive 204 to access a medium 206 on which the file or files are stored and access on a network server 208.

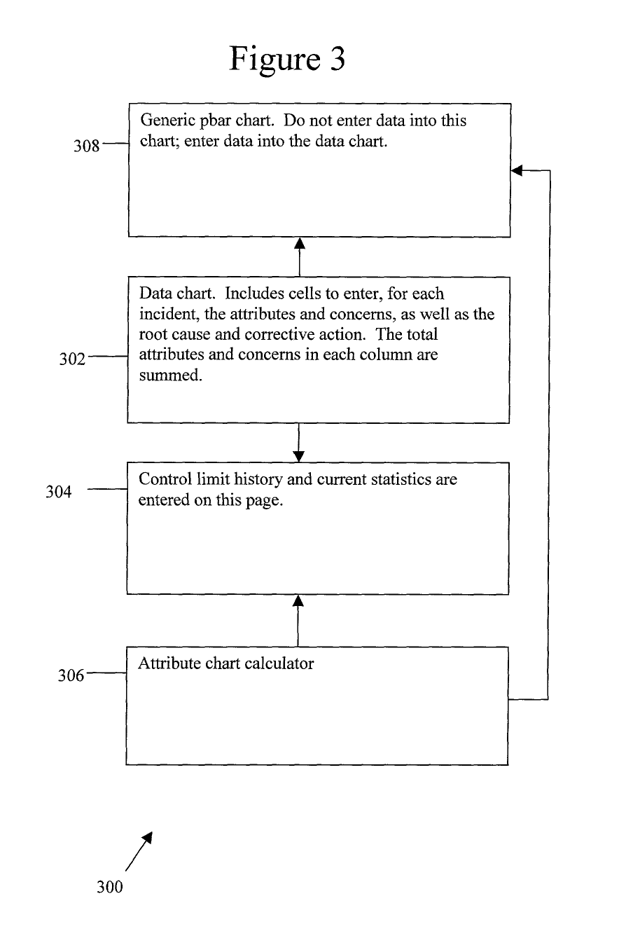

An overview of the organization of a spreadsheet file 300 that can be used in the preferred embodiment is shown in FIG. 3. A data chart 302 includes cells in which the user enters, for each incident, the attributes and concerns, as well as the root causes and corrective action. Each column represents a particular time at which data are to be entered, such as a shift change. The total attributes and concerns in each column are automatically summed using known spreadsheet techniques. A control limit history and current statistics (the current values of the upper and lower control limits used in analysis of the data) are entered in an area 304. An attribute chart calculator 306, linked to the cells in the data chart 302 by known spreadsheet techniques, performs the statistical calculations; in a preferred embodiment, the statistical calculations include the rate of occurrence of each attribute in parts per million and the upper and lower control limits. The upper and lower control limits as calculated by the attribute chart calculator 306 are supplied to the control limit history area 304 to supply the current statistics. Since spreadsheets can be recalculated on the fly, the attribute chart calculator 306 updates the statistical calculations as data are entered. The results of the calculation can also be graphed on the fly, using the graphical routines in the spreadsheet program, and displayed in the pbar chart 308.

In a spreadsheet program supporting multi-page spreadsheets, each of the portions 302, 304, 306, 308 can be implemented as a separate page in the spreadsheet file 300, accessible by clicking on a tab. Since the end result is displayed in the chart 308, the multi-page spreadsheet 300 still implements a single display.

A portion of the data chart 302 is shown in Table I below. The left column is a header giving the information that the user is to fill in. The right column is a representative column for a particular date and shift; of course, as many columns are provided as needed, and any other time division can be used as appropriate for the specific task at hand. As can be seen, in this particular embodiment, the user identifies a number for the total sample as well as the number of occurrences of each type of defect. Text cells are provided for the user to enter a root cause and a corrective action. Each column is totaled to give the number of attributes and concerns in each shift.

TABLE I
Data Chart (Partial View)

| | |
|---|---|
| Graph Start Date | |
| If the above date is blank, the | |
| last 25 data sets are graphed. | |
| Date | Jul. 2, 2001 |
| Shift | 2 |
| A-Airbag #1 & #2 | 1 |
| A-Circuit # 1-6 | |
| A-Centering Fault | |
| A-Leakage/Hi-Pot | |
| B-Airbag #1 & #2 | |
| B-Circuit #1-6 | 3 |
| B-Centering Fault | |
| B-Leakage/Hi-Pot | |
| C-Airbag #1 & #2 | 11 |
| C-Circuit #1-6 | 2 |
| C-Centering Fault | |
| C-Leakage/Hi-Pot | |
| Shorting Bar | 14 |
| Bad Squib | |
| Broken Tabs | |
| Other | 1 |
| Total Attributes/Concerns | 32 |
| Total Sample | 2,368 |
| Corrective Action: | |
| What was done to improve the | |
| process and/or bring it into control. | |
| Root Cause: | |
| Changes in: Manpower, | |
| Machine, Material, | |
| Method, Measurement, | |
| Mother Nature | |

other: 1 lower plug failure

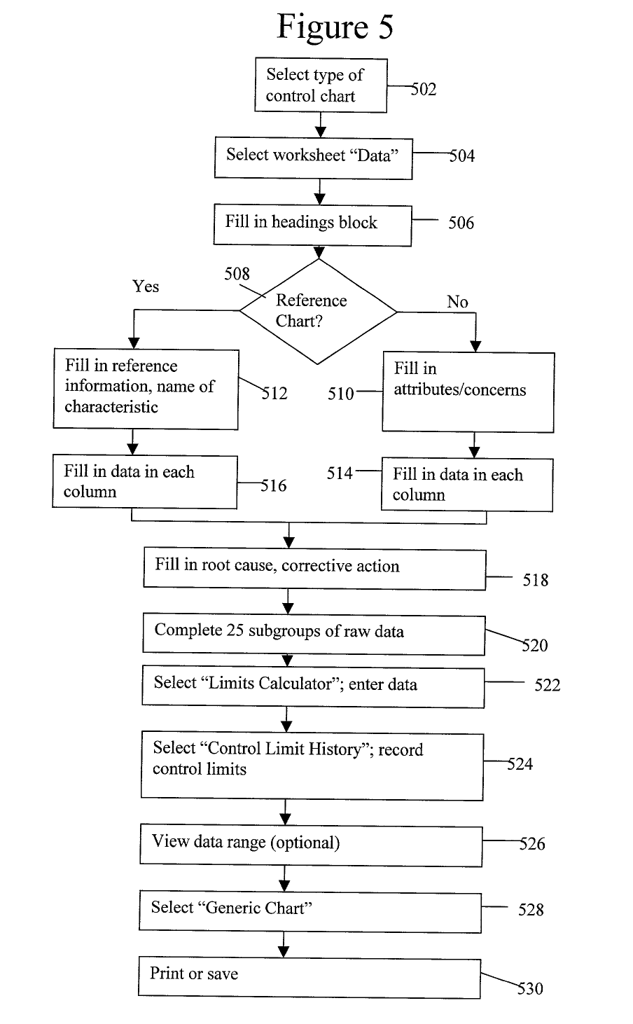

The control limit history and statistics portion 304 is shown in Table II below. The current statistics are obtained from the attribute chart calculator 306, whose functionality will be explained below. The history (data for each date) is manually entered, as will be explained below with reference to FIG. 5.

TABLE II
Control Limit History and Current Statistics

| Date | Feb. 21, 2001 |
|---|---|
| n bar | 2036 |
| UCLp | 22814 |
| p bar | 14788 |
| LCLp | None |
| History is entered above. | |
| Current Statistics are entered below. | |
| n bar | 2036 |
| UCLp | 22814 |
| p bar | 14788 |
| LCLp | None |

A portion of the attribute chart calculator 306 is shown in Table III below. As many rows are provided as needed. In each row, the PPM (parts per million) value in column C is calculated by dividing the value in column A by the value in column B and multiplying by 1,000,000. Each cell in column C has an appropriate formula for performing the calculation automatically.

TABLE III
Attribute Chart Calculator

| | (A) | | |
|---|---|---|---|
| | Total | (B) | |
| | Attributes | Total | (C) |
| Subgroup | Concerns | Sample | PPM |
| 1 | | | |
| 2 | | | |
| 3 | | | |
| 4 | | | |
| 5 | | | |

The attribute chart calculator 306 uses the data entered to compute control chart limits. The display of the results is shown in Table IV below. The value nbar is the mean value input into column B and is computed as the total in column B divided by the number of entries in column A. The value pbar is the mean error rate in parts per million and is the quotient of the divisor (total in column A) and dividend (total in column B). The values UCLp and LCLp are the upper and lower control limits for pbar and are calculated from nbar and pbar.

TABLE IV
Control Chart Limits
Control Chart Limits

nbar =
UCLp =
p bar =
LCLp =

The generic pbar chart 308 includes formulas, with links to the appropriate cells in the data chart 302, the control limit history and current statistics 304, and the attribute chart calculator 306, for compiling all of the entered information, performing the needed statistical calculations on it, and displaying the results on one page. That page can then be printed or saved to disk as needed.

The user does not enter any information into the chart 308 itself In fact, depending on the capabilities of the spreadsheet file format in which the spreadsheet 300 is created, the chart 308 can include a comment, which is visible on screen but does not print, warning the user not to enter data into the chart itself.

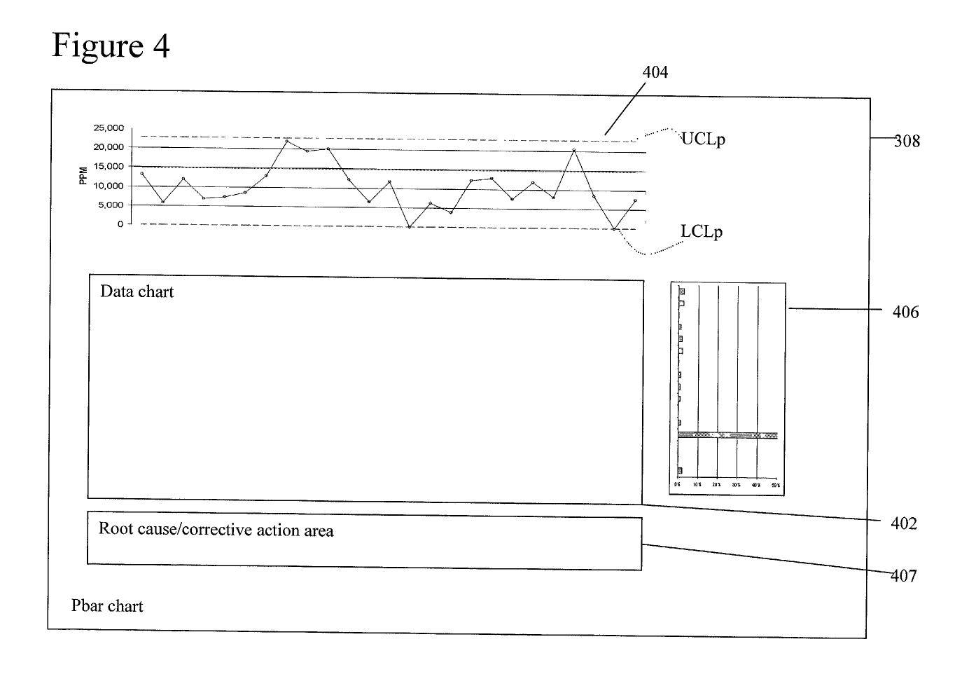

An overview of the chart 308 is shown in FIG. 4. The chart 308 includes a data chart 402, which reproduces, in non-editable form, the data entered into the data chart 302. IN the data chart 402, each row is totaled to give the number of occurrences of each attribute or concern over all of the shifts. Graphical representations of the data in the chart 402 are generated on the fly. For example, a chart 404 of error rates in PPM is generated and placed over the data chart 402, with each data point aligned with the corresponding column. The upper and lower control limits are marked in the chart 404 as UCLp and LCLp, respectively. Similarly, a Pareto chart 406 is generated and placed to the right of the data chart 402, with each bar aligned with the corresponding row. The root cause and corrective action section for each subgroup is shown as 407. Of course, any other suitable graphs and other information can be provided. The chart 308 provides a single display of all pertinent information that can be saved or printed.

The way in which the spreadsheet file 300 is used will now be described with reference to the flow chart of FIG. 5. In step 502, the type of control chart for analysis is selected. The options provided can by any options suitable to the task at hand and include the following:

1. P bar PPM

2. P bar Reference (raw data with 0 decimal places)

3. P bar (% raw data with 0 decimal places)

4. P bar (% raw data with 1 decimal place)

5. P bar (% raw data with 2 decimal places)

6. C bar Reference (raw data with 0 decimal places)

7. C bar (raw data with 0 decimal places)

8. C bar (raw data with 1 decimal place)

9. C bar (raw data with 2 decimal places)

In step 504, the user selects the data chart 302 (the worksheet labeled “Data” in the spreadsheet file 300) by clicking on the appropriate tab. In step 506, the user fills in the headings block to identify what is being analyzed. In a particular embodiment, the user fills in the headings blocks at top of the worksheet, starting with “Graph Start Date,” “Factory,” “Product Code,” “Product Description,” and “Chart Title.”

For non-reference charts, as determined in step 508, the user fills in the Attributes/Concerns listing in step 510. For reference charts, in step 512, the user fills in the reference information and types in the name of the characteristic to be charted by changing “graph value” to that characteristic.

For non-reference charts, in step 514, the user fills in the data in each column. The user starts with the date and proceeds down, filling in the shift, providing the number of occurrances of each attribute. As noted above, the attributes will total automatically.

For reference charts, in step 516, the user fills in the data in each column. The user starts with the date and proceeds down, filling in the shift, the amount of each reference information and number of the graph value characteristic.

In step 518, the user fills in the root cause and corrective action as a summary of significant events. Once the user has completed 25 subgroups (columns) of raw data in step 520, the user selects the worksheet “Limits Calculator” (attribute chart calculator 306, see Table III above) in step 522 and enters the data, (25 subgroups needed). All blanks must be filled; if there are no data, the user must enter 0. Control limits will be calculated automatically.

In step 524, the user selects the worksheet “Control limit History” 304 and records the control limits. This will plot the limits on the generic chart 308. Limits can be predetermined and entered. The control limits may be changed by date range.

In an optional step 526, to view a date range, the user selects the “Data” 302 and enters a graph start date. A date must be entered. If the graph start date is left blank, the last 25 data sets are graphed automatically.

In step 528 the user select the worksheet “Generic Chart” 308 and reviews the chart statistics from the data entered. The data entry steps described above will have resulted in automatic calculation of the statistics and graphs shown in the generic chart 308. In step 530, the user prints or saves the generic chart 308 as needed.

While a preferred embodiment of the present invention has been set forth above, those skilled in the art who have reviewed the present disclosure will readily appreciate that other embodiments can be realized within the scope of the invention. For example, any desired calculations or graphs can be included. Also, the file 300 can be adapted for use with any suitable spreadsheet or other program. Therefore, the present invention should be construed as limited only by the appended claims.

What is claimed is:

1. A system for implementing a statistical process chart, the system comprising:
(a) a computing device having a memory; and
(b) in the memory of the computing device, a file in which the statistical process chart is implemented, the file comprising:
(i) a first area for entry of data to be analyzed;
(ii) code for analysis of the data to produce a result of analysis; and
(iii) a second area for displaying both the data and the result of analysis in a single display.

2. The system of claim 1, wherein the first area comprises cells for entry of a root cause and an action taken with regard to the data.

3. The system of claim 1, wherein the file is a spreadsheet file.

4. The system of claim 3, wherein the spreadsheet file comprises a plurality of pages, and wherein the first area is on a single one of the plurality of pages.

5. The system of claim 4, wherein the first area and the second area are on different ones of the plurality of pages.

6. The system of claim 1, wherein the result of analysis comprises a graphical chart.

7. The system of claim 6, wherein the graphical chart is a chart of an error rate derived from the data.

8. The system of claim 7, wherein the result of analysis further comprises upper and lower control limits of the error rate.

9. The system of claim 6, wherein the graphical chart is a Pareto chart.

10. The system of claim 6, wherein the second area displays the data in a table.

11. The system of claim 10, wherein the graphical chart comprises graphical elements that are aligned with corresponding columns or rows of the table.

12. The system of claim 11, wherein the graphical elements are bars in a bar chart.

13. The system of claim 11, wherein the graphical elements are data points on a curve on the graphical chart.
